(19) United States
(12) Patent Application Publication
(10) Pub. No.: US 2010/0212115 A1
(43) Pub. Date: Aug. 26, 2010

(54) Holder

(76) Inventor: Alexandra Armstrong, Queensland (AU)

Correspondence Address: SHOEMAKER AND MATTARE, LTD, 10 POST OFFICE ROAD - SUITE 100, SILVER SPRING, MD, 20910, US

(21) Appl. No.: 12/663,435

(22) PCT Filed: Jun. 13, 2008
(86) PCT No.: PCT/AU2008/000837

§ 371 Date: Dec. 16, 2009

(30) Foreign Application Priority Data
Jun. 13, 2007 (AU) 2007903160

(51) Int. Cl. B25G 1/00

(52) U.S. Cl. 16/422

(57) ABSTRACT

The present invention is a holder for use by a person such as an infant, elderly person or disabled person to hold a food item or eating utensil such as a spoon, fork or knife. The holder has an elongate handle portion, guard portion and a holding portion. The guard portion is positioned between the handle and the holding portion whereas the holding portion has a recess and a collar surrounding the recess. The collar is resiliently deformable to accommodate and hold the item within the recess.

### FIELD OF INVENTION

The present invention relates to a holder for a baby, toddler or young child. The present invention has particular but not exclusive application for training a young child to use an eating utensil or feed themselves.

### BACKGROUND OF THE INVENTION

Young children who are in the process of developing their movement, coordination and fine motor skills have difficulty gripping items with their hands. This is very frustrating for a parent who is training the child to use an eating utensil, grip food items and feed themselves. The child would frequently release the utensil or food item from their grasp and drop the item on the ground. The parent repeatedly picks the item up from the ground. Often the item becomes dirty when dropped on the ground and has to be washed before being given back to the child or discarded.

To address the issue of holding food items, holders with child user friendly grip have been developed. A food holder is described in UK Patent No. 25501. The holder also functions as a teething pad. The holder disclosed in UK Patent No. 25501 has a clip pad with a ring shaped handle. A ribbon or cord is attachable to the ring shaped handle. An item is clamped between the flat portions of the clip pad, and the child holds the item by gripping the handle of the holder.

The clip pad of the holder however, cannot hold items with curved surfaces, such as a cylindrically shaped biscuits such as rusks and spoon or fork handles. Furthermore, a young child may have difficulty gripping the ring because of the thickness of the ring.

### OBJECT OF THE INVENTION

It is an object of the present invention to provide an alternative holder which overcomes at least in part one or more of the above mentioned disadvantages.

### SUMMARY OF THE INVENTION

In one aspect the present invention broadly resides in a holder for use by a person having

an elongate handle portion, guard portion and a holding portion, said guard portion is positioned between the handle and the holding portion, said holding portion has a recess and a protruding collar surrounding the recess wherein said collar is resiliently deformable to accommodate and hold an item within the recess.

The recess is preferably substantially circular.

The protruding collar preferably forms a periphery about the recess.

The collar is preferably shaped to accommodate wide and curved items so that at least part of the collar abuts the item to retain and maintain its position.

The collar is preferably made of a resiliently deformable material such as a soft rubber or plastic.

In one embodiment of the invention, the collar is specifically shaped to form a close fit with an end of the item. The item that may be held by the collar include a rusk-type biscuit, carrot stick, or other food item, eating utensil, toothbrush attachment, rattle, pen, crayon or other article.

In a preferred embodiment of the invention, the collar has a substantially circular flange.

In another preferred embodiment, the collar has a plurality of protruding flanges that form a peripheral edge surrounding a recess. More preferably there is a plurality of flanges with a spacing between adjacent flanges. The separated flanges preferably allow different shaped items to be held within the recess.

The handle portion preferably has an enlarged section to facilitate gripping by a young child. The enlarged portion preferably is positioned at a lower end of the handle portion remote from the guard portion.

In one embodiment of the invention, the enlarged section has positioning grooves for guiding fingers around the handle. Preferably, there are three to five positioning grooves. More preferably, the positioning grooves are shaped and orientated to correspond to the position of the fingers of a young child or an elderly person when gripped around the handle.

The hand guard is preferably connected to or integral with the handle portion. Preferably, the hand guard is an arcuate portion that is attached to or integral with the handle portion and forms a space for a hand to grip about the handle portion.

The lower end of the handle portion preferably has an attachment section for the attachment of a cord with or without a clip. The lower end of the handle portion preferably has a hole for attaching a cord with or without a clip.

The hand guard is preferably disc shaped. The hand guard is preferably shaped to prevent the hand guard from entering a person's mouth.

The holder is preferably made of a durable material that withstands temperatures used for sterilization. More preferably the durable material includes soft rubber or plastic.

The holder may be suitably decorated for appealing to children.

### BRIEF DESCRIPTION OF THE DRAWINGS

In order that the present invention can be more readily understood reference will now be made to the accompanying drawings which illustrate preferred embodiments of the invention and wherein:

FIG. 1 is a diagrammatic view of a holder according to a first embodiment of the present invention;

FIG. 2 is a diagrammatic view of a holder according to a second embodiment of the present invention showing the holder holding a rusk;

FIG. 3 is a diagrammatic view of a holder according to a third embodiment of the present invention that can hold a fork, a spoon or a rusk;

FIG. 4 is a diagrammatic view of a holder according to a fourth embodiment of the present invention showing positioning grooves on the handle;

FIG. 5 is a diagrammatic view of a holder according to a fifth embodiment of the present invention showing a hand guard forming part of the handle; and

FIG. 6 is a diagrammatic view of a holder according to a sixth embodiment of the present invention showing a different type of collar.

### DETAILED DESCRIPTION OF THE PREFERRED EMBODIMENTS

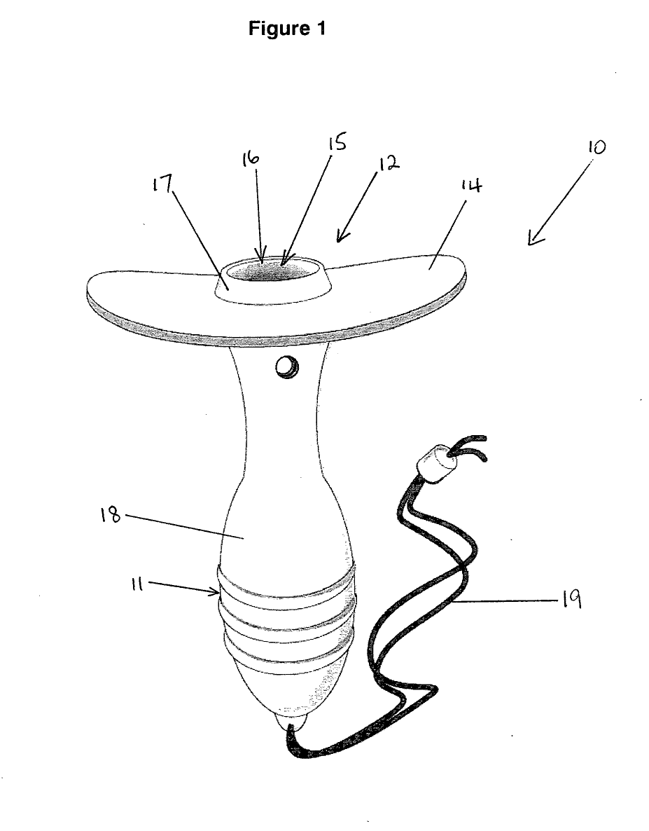

With reference to FIG. 1, there is shown a holder 10 used to assist a child feed themselves by gripping a food item such as a rusk or an eating utensil. The holder 10 has an elongate handle 11, a holding portion 12 and a disc shaped guard 14.

The holding portion 12 has a recess 15 with an opening 16 that is surrounded by a collar 17. The collar 17 forms a perimeter about the opening 16. The collar 17 is substantially circular. The collar 17 is made of a soft rubber or plastic material that is resiliently deformable to hold the item inserted within the recess 15. All or part of the collar 17 abuts the inserted item to hold and maintain the position of the item.

The handle 11 has an enlarged portion 18 at a lower end of the handle 11 that is remote from the guard 14. A cord 19 is fixed to the lower end of the enlarged portion 18.

The holder and in particular the handle may have various designs and colours to appeal to different children. The holders can be made of durable rubber or plastic that can withstand temperatures used for sterilization.

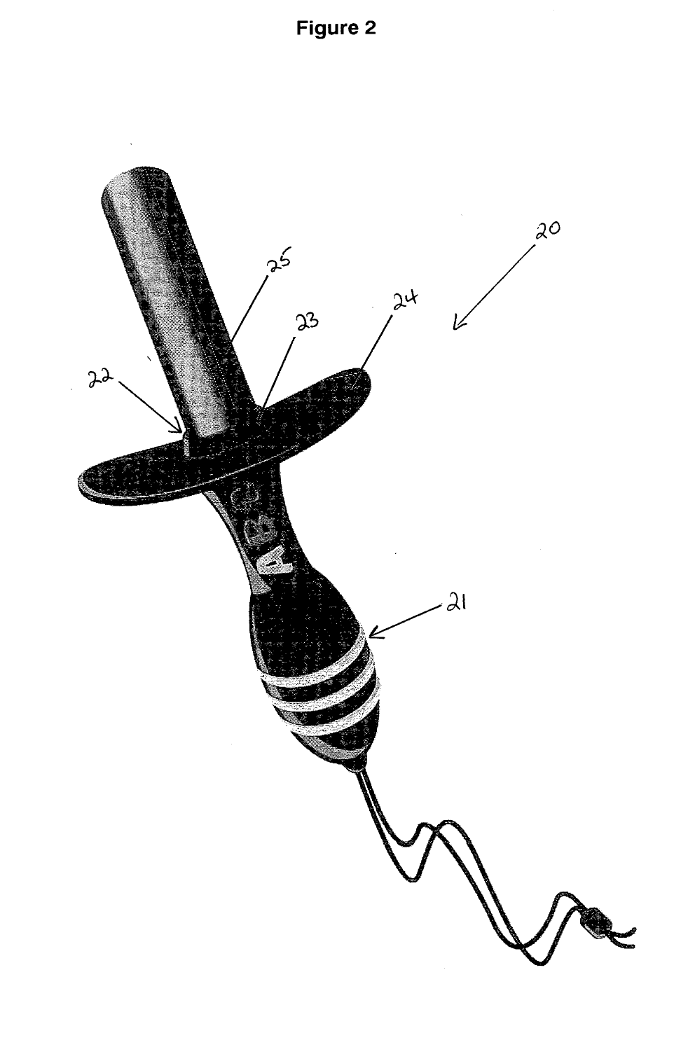

With reference to FIG. 2, there is shown another embodiment of the holder 20. The holder 20 has similar features to the holder 10 described above. The holder 20 has an elongate handle 21, a holding portion 22 that includes a recess (not shown) and a collar 23 and a guard 24. The end of a biscuit rusk 25 is positioned in the recess of the holding portion 22. The recess of the holder 20 has a depth that is the same as or deeper than the height of the collar 23. The collar 23 forms a close fit about the periphery of the end of a rusk 25 so that it does not fall out.

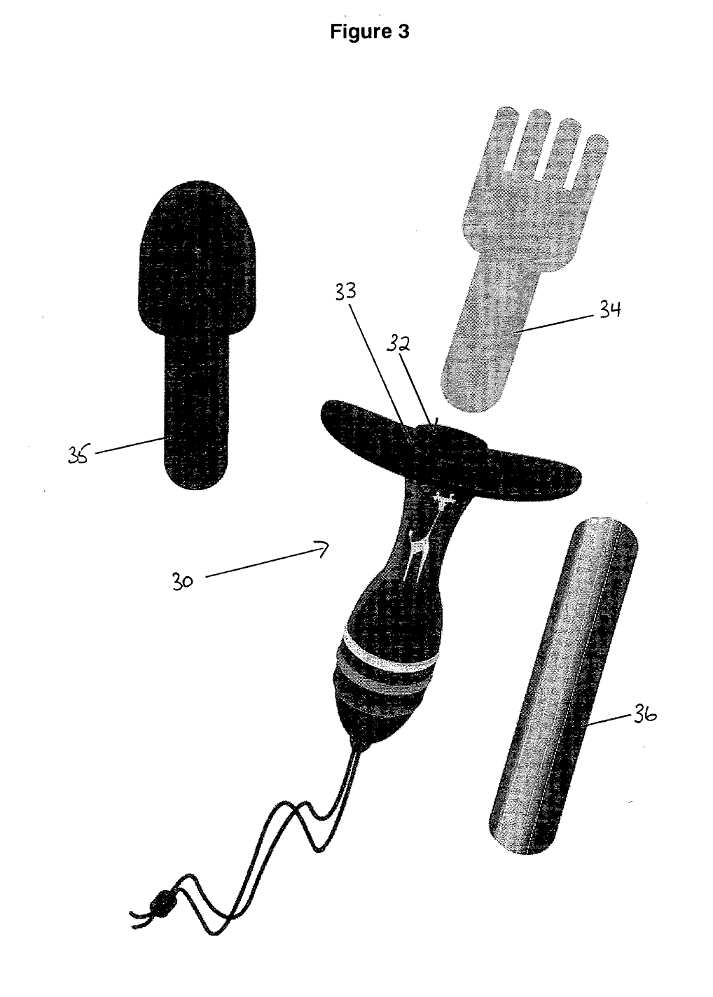

With reference to FIG. 3, there is shown another embodiment of the holder 30. The holder 30 has the similar features to holder 10 described above except that the recess 32 and collar 33 are shaped to accommodate the end of a fork 34, spoon 35 or rusk 36. The shape and size of the collar 33 releasably retains the end of the fork 34, spoon 35 and rusk 36 by gripping at least part of the periphery of the inserted item.

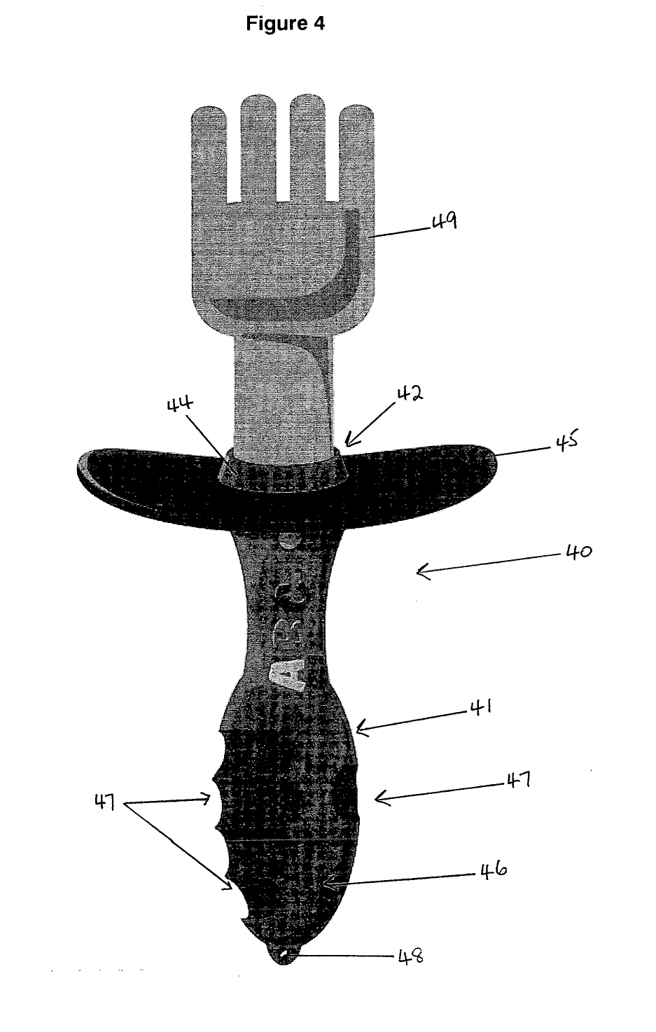

With reference to FIG. 4, there is shown another embodiment of a holder 40. The holder 40 has similar features to holder 10 described above. Holder 40 has an elongate handle 41, a holding portion 42 with a recess and a collar 44, and a guard portion 45 positioned between the handle 41 and holding portion 42. The handle 41 has an enlarged portion 46 at a lower part of the handle 41 that has five positioning grooves 47. Additionally, the lower end of the handle 41 has a hole 48 that can be used for attaching a cord with or without a clip.

The positioning grooves 47 are shaped and orientated to match the position of the five fingers of a person when a firm grip is formed around the handle 41. The positioning grooves 47 provide a guide for a young child, or a person with disabilities, to form a grip around the handle 41.

With the insertion of an eating utensil such as a fork 49, a young child can be trained to use the eating utensil.

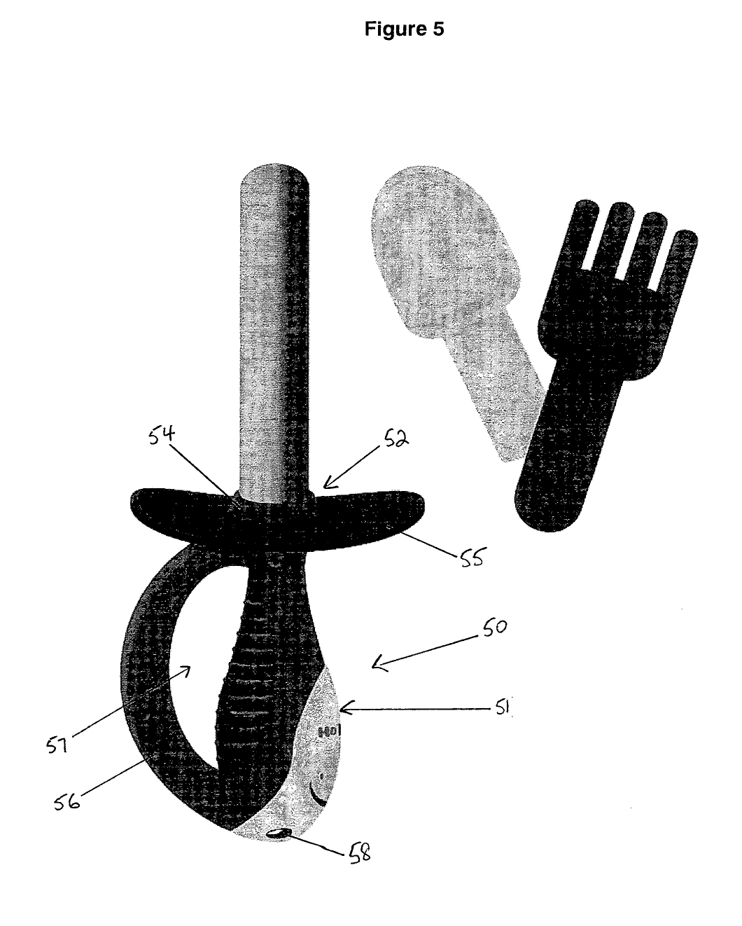

With reference to FIG. 5, there is shown another embodiment of the holder 50. The holder 50 has similar features to the holder 10 described above. Holder 50 has an elongate handle 51, a holding portion 52 with a recess and a collar 54, and a guard portion 55. The holder 50 also has a hand guard 56 that protects the hand of the young child gripping the holder 50. The position of the hand guard 56 provides a space 57 between the handle 51 and the hand guard 56 for allowing a hand to pass through and grip the handle 51.

The holder 50 has a hole 58 at a lower end of the handle 51. The hole 58 can be used for attaching a cord with or without a clip.

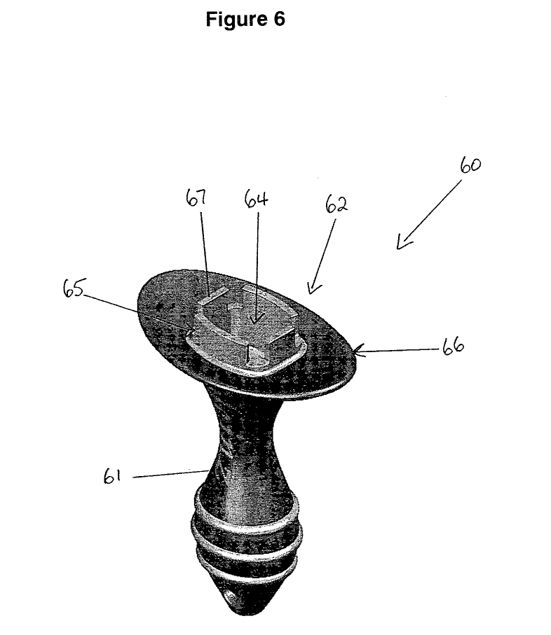

With reference to a further embodiment shown in FIG. 6, there is a holder 60 having an elongate handle 61, a holding portion 62 with a recess 64 and a collar 65, and a guard portion 66. The collar 65 includes a plurality of outwardly projecting flanges 67 surrounding the recess 64. The flanges 67 enables an item such as a rusk, fork, spoon or knife to fit and be retained within the recess 64.

Using the holder 10 by way of example, a rusk, carrot stick, eating utensil, pen or other article is placed in the recess 15 and held by the abutting collar 17. The cord 19 is then placed around the wrist of the person. The holder 10 with an item held in place in the holding portion 12 can then be given to a disabled person or child. The enlarged portion 18 facilitates the gripping of the handle 11, while the cord 19 prevents the item from being dropped onto the ground. The person or child can therefore be trained to hold an item in his or her hand without the item being constantly dropped on the ground and soiled. Furthermore, the guard 14 serves to stop the child from swallowing and choking on the holder.

### ADVANTAGES

An advantage of one of the embodiments of the holder include having a holding portion with a collar that is specifically designed to hold a rusk or eating utensil with a substantially round cross section.

The preferred embodiment of the holder is for use by a person such as an infant, elderly person or disabled person to hold a food item or eating utensil such as a spoon, fork or knife. The holder has an elongate handle portion, guard portion and a holding portion. The guard portion is positioned between the handle and the holding portion whereas the holding portion has a recess and a collar surrounding the recess. The collar is resiliently deformable to accommodate and hold the item within the recess.

An embodiment of the holder that has a cord or clip provides the advantage of attaching the holder to the user and therefore prevents the holder and item held by the holder, from being dropped on the ground and soiled.

Another advantage of one of the embodiments of the holder is that positioning grooves made in the handle can help a young child or a person with disabilities form a grip around the handle. The holder can be used to train a young child or person with disabilities to develop correct finger positioning aiding in the development of fine motor skills.

A further advantage of embodiments of the holder is that the guard portion prevents the user choking on the holder.

### Variations

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims this specification the word “comprise” and variations of that word such as “comprises” and “comprising”, are not intended to exclude other additives, components, integers or steps.

1-15. (canceled)

16. A holder for use by a person said holder having
an elongate handle portion,
a hand guard portion and
a holding portion,
said hand guard portion being positioned between the handle portion and the holding portion,
said holding portion having a substantially circular recess and a protruding collar surrounding the recess wherein said collar is resiliently deformable to accommodate and hold an item within the recess.

17. A holder for use by a person, said holder having
an elongate handle portion,
a hand guard portion and
a holding portion,
said guard portion being positioned between the handle portion and the holding portion,
said holding portion having a substantially circular recess and a protruding collar forming a periphery about the recess,
said guard portion being substantially disc shaped and wider than the width of the handle portion, wherein said collar is resiliently deformable to accommodate and hold an item within the recess.

18. A holder as claimed in claim 16, wherein the protruding collar is shaped to accommodate wide and curved items so that at least part of the collar abuts the item to retain and maintain its position.

19. A holder as claimed in claim 16, wherein the protruding collar is made of a resiliently deformable material such as a soft rubber or plastic.

20. A holder as claimed in claim 16, wherein the protruding collar is specifically shaped to form a close fit with an end of the item.

21. A holder as claimed in claim 16, wherein the item that can be held by the protruding collar is selected from a rusk-type biscuit, carrot stick, or other food item, eating utensil, toothbrush attachment, rattle, pen, crayon or other article.

22. A holder as claimed in claim 16, wherein the collar has a substantially circular flange.

23. A holder as claimed in claim 16, wherein the collar has a plurality of protruding flanges that form a periphery surrounding a recess.

24. A holder as claimed in claim 16, wherein the collar has a plurality of protruding flanges that form a periphery surrounding a recess and there is a spacing between adjacent flanges.

25. A holder as claimed in claim 16, wherein the handle portion has an enlarged section to facilitate gripping by a young child or an elderly person and the enlarged portion is positioned at a lower end of the handle portion remote from the guard portion.

26. A holder as claimed in claim 25, wherein the enlarged section has positioning grooves for guiding fingers around the handle portion.

27. A holder as claimed in claim 16, wherein the hand guard is connected to or integral with the handle portion.

28. A holder as claimed in claim 16, wherein the hand guard is shaped to prevent the hand guard from entering a person's mouth.

29. A holder as claimed in claim 16, wherein a lower end of the handle portion has an attachment section for attachment of a cord.
